(19) United States
(12) Patent Application Publication
(10) Pub. No.: US 2018/0103681 A1
(43) Pub. Date: Apr. 19, 2018

(54) METHODS AND SYSTEMS FOR INCREASING STABILITY OF THE PRE-VAPOR FORMULATION OF AN E-VAPING DEVICE

(71) Applicant: Altria Client Services LLC, Richmond, VA (US)

(72) Inventor: Marc W. FARISS, Midlothian, VA (US)

(73) Assignee: Altria Client Services LLC, Richmond, VA (US)

(21) Appl. No.: 15/296,616

(22) Filed: Oct. 18, 2016

(51) Int. Cl. A24B 15/16; A24F 47/00; H05B 1/02

(52) U.S. Cl. CPC A24B 15/167; H05B 2203/021; H05B 1/0244; A24F 47/008

(57) ABSTRACT

A pre-vapor formulation of an e-vaping device including a vapor former configured to form a vapor, nicotine, at least one or more ion exchangers, one or more chelating agents and optionally acids. The one or more ion exchangers include Dowex 50W-X8, Lewait CNP 80 or Amberlite IR-120. The pre-vapor formulation may also include chelating agents such as EDTA, DTPA and NTA. The concentration of the ion exchangers may be between about 0.1% and about 5% and the concentration of the chelating agents may be between about 0.001% and 0.05%.

### BACKGROUND OF THE INVENTION

### Field of the Invention

Some example embodiments relate generally to a pre-vapor formulation of an electronic vaping device, and/or to a method of increasing the stability of ingredients of the pre-vapor formulation.

### Related Art

Electronic vaping devices are used to vaporize a liquid material into a vapor in order for an adult vaper to draw the vapor through outlet(s) of the e-vaping device. These electronic vaping devices may be referred to as e-vaping devices. An e-vaping device may typically include several e-vaping elements such as a power supply section and a cartridge. The power supply section includes a power source such as a battery, and the cartridge includes a heater along with a reservoir capable of holding the pre-vapor formulation or liquid material. The cartridge typically includes the heater in communication with the pre-vapor formulation via a wick, the heater being configured to heat the pre-vapor formulation to produce a vapor. The pre-vapor formulation typically includes an amount of nicotine as well as a vapor former and possibly water, acids, flavorants and/or aromas. The pre-vapor formulation includes a material or combination of materials that may be transformed into a vapor. For example, the pre-vapor formulation may include a liquid, solid and/or gel formulation including, but not limited to, water, beads, solvents, active ingredients, ethanol, plant extracts, natural or artificial flavors, and/or vapor formers such as glycerin and/or propylene glycol.

In some instances, ingredients of the pre-vapor formulation in the pre-vapor formulation container may react with other ingredients, or with solid metallic portions of the pre-vapor formulation container or cartridge. For example, particularly when “dry drawing” occurs, which is when the wick of the e-vaping device is not sufficiently supplied with pre-vapor formulation prior to puff initiation by the adult vaper, if the cartridge is empty, or if a coil or portion of the heater is overheating during operation of the e-vaping device, ingredients of the pre-vapor formulation may react with the metal(s) of the solid portions of the e-vaping device, such as copper, nickel or iron, in the presence of oxygen, and may generate reactive free radicals such as, for example, hydroxyl radicals. For example, metal ions such as copper ions Cu²⁺ may react with oxygen or hydrogen peroxide and generate free radicals such as free hydroxyl radicals. Alternatively, the free radicals may be generated via oxidation of the metallic portions of the cartridge or pre-vapor formulation container. The oxidation of pre-vapor formulation ingredients, the cartridge or the container is typically dependent on the presence of oxygen and a redox-active transition metal producing reactive oxygen species such as hydroxyl radicals. The redox-active transition metal may come from metallic portions of the cartridge or container, or may be contained in other components added to the pre-vapor formulation such as nicotine, water, vapor formers such as glycerin and/or propylene glycol, acids, flavorants and/or aromas.

Accordingly, once generated by the metallic portions of the e-vaping device, the reactive free hydroxyl radicals may react with ingredients of the pre-vapor formulation. The free radicals may also mix with the vapor generated by the e-vaping device.

### SUMMARY OF THE INVENTION

At least one example embodiment relates to a pre-vapor formulation of an e-vaping device.

In one example embodiment, the pre-vapor formulation includes at least one ion exchanger as well as nicotine, a combination of glycerol and/or propylene glycol, optionally flavorants and optionally organic acids. In example embodiments, the ion exchanger is configured to bind to free transition metals and may include insoluble resins or particles, the resins or particles being in a range of about 0.03 mm to about 0.5 mm in size. In example embodiments, the ion exchanger or adsorbant may be included in the pre-vapor formulation at a concentration in a range of, for example, about 0.1% to about 5% by weight of the pre-vapor formulation, and for example about 0.1% to about 0.5%, about 0.5% to about 1%, about 1% to about 2%, about 2% to about 4%, and about 4% to about 5%.

In example embodiments, because the reaction of ingredients of the pre-vapor formulation results from the presence of hydroxyl radicals generated from free transition metals such as copper, nickel or iron, in the presence of oxygen or hydrogen peroxide generated from oxygen, the addition of the insoluble ion exchangers, which are scavengers or binders of free transition metals and oxygen, substantially prevents the formation of the free hydroxyl radicals by substantially reducing the amount of redox-active transition metals and the amount of oxygen in the pre-vapor formulation. For example, the ion exchangers discussed above may bind to the free transition metal ions after releasing hydrogen or sodium, and thus may prevent or substantially reduce the formation of hydroxyl free radicals. Likewise, ion exchangers for oxygen discussed above remove oxygen from the pre-vapor formulation resulting in a dramatic reduction in the formation of hydroxyl free radicals. As such, the free transition metals that may be generated by solid portions of the e-vaping device are substantially prevented from transferring into the vapor or reacting with other ingredients of the pre-vapor formulation to form free radicals such as, for example, hydroxyl radicals. Accordingly, the stability of the pre-vapor formulation is increased.

In one example embodiment, the ion exchangers may include Dowex 50W-X8, or styrene-divinylbenzene, which is a sulfonic acid functional group, in the form of a fine mesh of spherical particles in H+ or Na+ ionic form and in a size range of about 0.03 mm to about 0.3 mm. Dowex 50W-X8 is a strongly acidic, cation exchanger particle and is typically used in, for example paper chromatography or as a stripper resin. In example embodiments, this ion exchanger is capable of binding metals such as Cu, Ni, Zn, Cd and Pb in an effective pH range of 1-14, which results in the release of H⁺ ions or Na⁺ ions.

In example embodiments, the ion exchangers may also include Lewait CNP 80, a crosslinked polyacrylate carboxylic acid, which is a weakly acidic, macroporous, acrylic-based cation exchanger resin having a bead size in a range of about 0.3 mm, a substantially high operating capacity and good chemical and mechanical stability. Lewait CNP 80 is capable of binding the heavy metals such as Cu, Ni, Zn, Cd and Pb.

In example embodiments, the ion exchangers may also include Amberlite IR-120, a styrene divinylbenzene copolymer, which is a strongly acidic (sulfonic acid), cation exchange resin having spherical particles in H⁺ or Na⁺ ionic form. Amberlite IR-120 is typically insoluble in water and in most common solvents, is stable at elevated temperatures, and has a high exchange capacity over a wide pH range. Amberlite IR-120 is effective in adsorbing heavy metals such as Cu, Ni, Zn, Cd and Pb.

In example embodiments, the ion exchangers or adsorbants discussed above may reduce or substantially prevent oxidation of ingredients of the e-vaping device by substantially preventing the formation of free radicals, such as free hydroxyl radicals, by binding the transition metals such as copper, nickel and iron present in portions of the e-vaping device. Accordingly, free radicals, such as free hydroxyl radicals are substantially prevented from forming and thus from reacting with the ingredients of the pre-vapor formulation, or from transferring into the vapor generated during operation of the e-vaping device and reacting with formulation ingredients resulting in long-lived reactive free radicals. As a result, a longer shelf life of the pre-vapor formulation of the e-vaping device may be achieved, and potential harmful effects to the adult vaper may be reduced or substantially prevented.

In example embodiments, the wick of the e-vaping device may be formed of, or may include, ion exchangers or adsorbants. For example, the wick may be formed of, or include, nanocrystalline cellulose in the form of a transparent film. The cellulose nanoadsorbent is capable of removing heavy metal ions such as, for example, Cu, from aqueous solutions.

In example embodiments, the ion exchangers or adsorbents may be combined with other agents such as sequestering agents of heavy metals or chelators. The sequestering agents may also include high affinity, low capacity chelators such as ethylenediaminetetraacetic acid (EDTA), diethylene triamine pentaacetic acid (DTPA), nitrilotriacetic acid (NTA) adsorbants, and high capacity, low affinity ion exchange agents. In example embodiments, the chelators or chelating agents such as, for example, EDTA, may be included in the pre-vapor formulation at a concentration in a range of, for example, 0.001% to about 0.05%, and for example about 0.001% to about 0.01%, about 0.01% to about 0.02%, and about 0.02% to about 0.05%. The sequestering agents such as the chelators discussed above may bind to the free redox-active transition metals and thus prevent the formation of a free radical, such as free hydroxyl radical. As such, the free transition metals that are generated by solid portions of the e-vaping device are substantially prevented from transferring into the vapor, or reacting with other ingredients of the pre-vapor formulation. Accordingly, the stability of the pre-vapor formulation is increased.

In example embodiments, the ion exchangers in combination with the sequestering agents may reduce or substantially prevent the oxidation of ingredients of the e-vaping device by sequestering or binding with the free metals generated by transition metals such as copper, nickel and iron present in portions of the e-vaping device, and substantially preventing the formation of hydroxyl radicals. Accordingly, reducing or substantially preventing the formation of hydroxyl radicals reduces or substantially prevents the oxidation of the ingredients of the pre-vapor formulation, and reduces or substantially prevents the generation of additional free radicals in the pre-vapor formulation. As a result, a greater stability of the pre-vapor formulation of an e-vaping device may be achieved.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a side view of an e-vaping device, according to an example embodiment;

FIG. 2 is a longitudinal cross-sectional view of an e-vaping device, according to an example embodiment;

FIG. 3 is a longitudinal cross-sectional view of another example embodiment of an e-vaping device; and

FIG. 4 is a longitudinal cross-sectional view of another example embodiment of an e-vaping device.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations and/or elements, but do not preclude the presence or addition of one or more other features, integers, steps, operations, elements, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

When the terms “about” or “substantially” are used in this specification in connection with a numerical value, it is intended that the associated numerical value include a tolerance of ±10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%. Moreover, when the words “generally” and “substantially” are used in connection with geometric shapes, it is intended that precision of the geometric shape is not required but that latitude for the shape is within the scope of the disclosure. Although the tubular elements of the embodiments may be cylindrical, other tubular cross-sectional forms are contemplated, such as square, rectangular, oval, triangular and others.

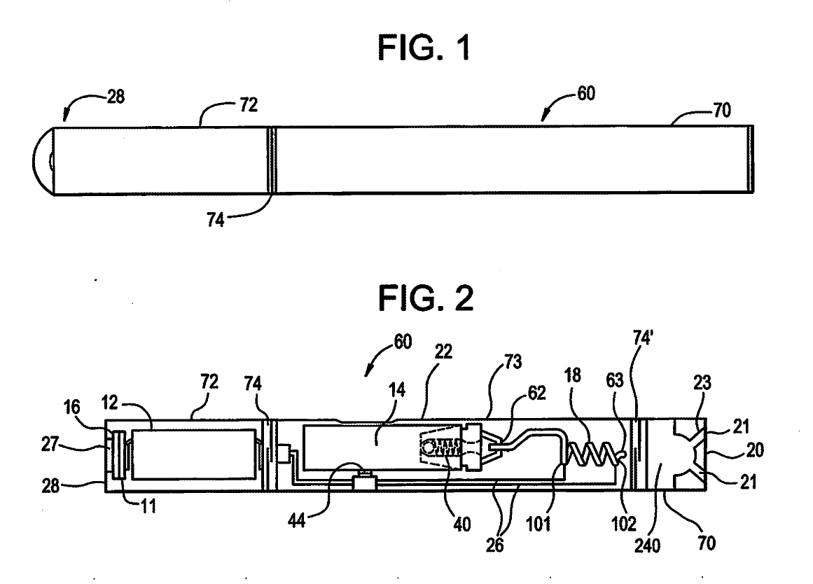

FIG. 1 is a side view of an e-vaping device or a “cigalike” device 60, according to an example embodiment. In FIG. 1, the e-vaping device 60 includes a first section or cartridge 70 and a second section 72, which are coupled together at a threaded joint 74 or by other connecting structure such as a snug-fit, snap-fit, detent, clamp and/or clasp or the like. In at least one example embodiment, the first section or cartridge 70 may be a replaceable cartridge, and the second section 72 may be a reusable section. Alternatively, the first section or cartridge 70 and the second section 72 may be integrally formed in one piece. In at least one embodiment, the second section 72 includes a LED at a distal end 28 thereof.

FIG. 2 is a cross-sectional view of an example embodiment of an e-vaping device. As shown in FIG. 2, the first section or cartridge 70 can house a mouth-end insert 20, a capillary capillary tube 18, and a reservoir 14.

In example embodiments, the reservoir 14 may include a wrapping of gauze about an inner tube (not shown). For example, the reservoir 14 may be formed of or include an outer wrapping of gauze surrounding an inner wrapping of gauze. In at least one example embodiment, the reservoir 14 may be formed of or include an alumina ceramic in the form of loose particles, loose fibers, or woven or nonwoven fibers. Alternatively, the reservoir 14 may be formed of or include a cellulosic material such as cotton or gauze material, or a polymer material, such as polyethylene terephthalate, in the form of a bundle of loose fibers. A more detailed description of the reservoir 14 is provided below.

The second section 72 can house a power supply 12, control circuitry 11 configured to control the power supply 12, and a puff sensor 16. The puff sensor 16 is configured to sense when an adult vaper is drawing on the e-vaping device 60, which triggers operation of the power supply 12 via the control circuitry 11 to heat the pre-vapor formulation housed in the reservoir 14, and thereby form a vapor. A threaded portion 74 of the second section 72 can be connected to a battery charger, when not connected to the first section or cartridge 70, to charge the battery or power supply section 12.

In example embodiments, the capillary tube 18 is formed of or includes a conductive material, and thus may be configured to be its own heater by passing current through the tube 18. The capillary tube 18 may be any electrically conductive material capable of being heated, for example resistively heated, while retaining the necessary structural integrity at the operating temperatures experienced by the capillary tube 18, and which is non-reactive with the pre-vapor formulation. Suitable materials for forming the capillary tube 18 are one or more of stainless steel, copper, copper alloys, porous ceramic materials coated with film resistive material, nickel-chromium alloys, and combinations thereof. For example, the capillary tube 18 is a stainless steel capillary tube 18 and serves as a heater via electrical leads 26 attached thereto for passage of direct or alternating current along a length of the capillary tube 18. Thus, the stainless steel capillary tube 18 is heated by, for example, resistance heating. Alternatively, the capillary tube 18 may be a non-metallic tube such as, for example, a glass tube. In such an embodiment, the capillary tube 18 also includes a conductive material such as, for example, stainless steel, nichrome or platinum wire, arranged along the glass tube and capable of being heated, for example resistively. When the conductive material arranged along the glass tube is heated, pre-vapor formulation present in the capillary tube 18 is heated to a temperature sufficient to at least partially volatilize pre-vapor formulation in the capillary tube 18.

In at least one embodiment, the electrical leads 26 are bonded to the metallic portion of the capillary tube 18. In at least one embodiment, one electrical lead 26 is coupled to a first, upstream portion 101 of the capillary tube 18 and a second electrical lead 26 is coupled to a downstream, end portion 102 of the capillary tube 18.

In operation, when an adult vaper draws on the e-vaping device, the puff sensor 16 detects a pressure gradient caused by the drawing of the adult vaper, and the control circuitry 11 controls heating of the pre-vapor formulation located in the reservoir 14 by providing power to the capillary tube 18. Once the capillary tube 18 is heated, the pre-vapor formulation contained within a heated portion of the capillary tube 18 is volatilized and emitted from the outlet 63, where the pre-vapor formulation expands and mixes with air and forms a vapor in mixing chamber 240.

As shown in FIG. 2, the reservoir 14 includes a valve 40 configured to maintain the pre-vapor formulation within the reservoir 14 and to open when the reservoir 14 is squeezed and pressure is applied thereto, the pressure being created when an adult vaper draws on the e-vaping device at the mouth-end insert 20, which results in the reservoir 14 forcing the pre-vapor formulation through the outlet 62 of the reservoir 14 to the capillary tube 18. In at least one embodiment, the valve 40 opens when a critical, minimum pressure is reached so as to avoid inadvertently dispensing pre-vapor formulation from the reservoir 14. In at least one embodiment, the pressure required to press the pressure switch 44 is high enough such that accidental heating due to the pressure switch 44 being inadvertently pressed by outside factors such as physical movement or collision with outside objects is avoided.

The power supply 12 of example embodiments can include a battery arranged in the second section 72 of the e-vaping device 60. The power supply 12 is configured to apply a voltage to volatilize the pre-vapor formulation housed in the reservoir 14.

In at least one embodiment, the electrical connection between the capillary tube 18 and the electrical leads 26 is substantially conductive and temperature resistant while the capillary tube 18 is substantially resistive so that heat generation occurs primarily along the capillary tube 18 and not at the contacts.

The power supply section or battery 12 may be rechargeable and include circuitry allowing the battery to be chargeable by an external charging device. In example embodiments, the circuitry, when charged, provides power for a given number of puffs, after which the circuitry may have to be re-connected to an external charging device.

In at least one embodiment, the e-vaping device 60 may include control circuitry 11 which can be, for example, on a printed circuit board. The control circuitry 11 may also include a heater activation light 27 that is configured to glow when the device is activated. In at least one embodiment, the heater activation light 27 comprises at least one LED and is at a distal end 28 of the e-vaping device 60 so that the heater activation light 27 illuminates a cap which takes on the appearance of a burning coal during a puff. Moreover, the heater activation light 27 can be configured to be visible to the adult vaper. The light 27 may also be configured such that the adult vaper can activate and/or deactivate the light 27 when desired, such that the light 27 is not activated during vaping if desired.

In at least one embodiment, the e-vaping device 60 further includes a mouth-end insert 20 having at least two off-axis, diverging outlets 21 that are uniformly distributed around the mouth-end insert 20 so as to substantially uniformly distribute vapor in an adult vaper's mouth during operation of the e-vaping device. In at least one embodiment, the mouth-end insert 20 includes at least two diverging outlets 21 (e.g., 3 to 8 outlets or more). In at least one embodiment, the outlets 21 of the mouth-end insert 20 are located at ends of off-axis passages 23 and are angled outwardly in relation to the longitudinal direction of the e-vaping device 60 (e.g., divergently). As used herein, the term “off-axis” denotes an angle to the longitudinal direction of the e-vaping device.

In at least one embodiment, the e-vaping device 60 is about the same size as a tobacco-based product. In some embodiments, the e-vaping device 60 may be about 80 mm to about 110 mm long, for example about 80 mm to about 100 mm long and about 7 mm to about 10 mm in diameter.

The outer cylindrical housing 22 of the e-vaping device 60 may be formed of or include any suitable material or combination of materials. In at least one embodiment, the outer cylindrical housing 22 is formed at least partially of metal and is part of the electrical circuit connecting the control circuitry 11, the power supply 12 and the puff sensor 16.

As shown in FIG. 2, the e-vaping device 60 can also include a middle section (third section) 73, which can house the pre-vapor formulation reservoir 14 and the capillary tube 18. The middle section 73 can be configured to be fitted with a threaded joint 74′ at an upstream end of the first section or cartridge 70 and a threaded joint 74 at a downstream end of the second section 72. In this example embodiment, the first section or cartridge 70 houses the mouth-end insert 20, while the second section 72 houses the power supply 12 and the control circuitry 11 that is configured to control the power supply 12.

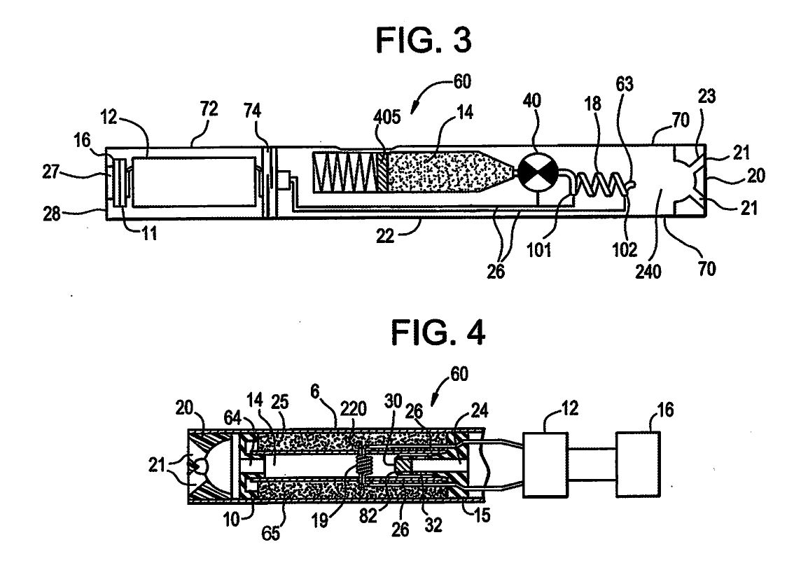

FIG. 3 is a cross-sectional view of an e-vaping device according to an example embodiment. In at least one embodiment, the first section or cartridge 70 is replaceable so as to avoid the need for cleaning the capillary tube 18. In at least one embodiment, the first section or cartridge 70 and the second section 72 may be integrally formed without threaded connections to form a disposable e-vaping device.

As shown in FIG. 3, in other example embodiments, a valve 40 can be a two-way valve, and the reservoir 14 can be pressurized. For example, the reservoir 14 can be pressurized using a pressurization arrangement 405 configured to apply constant pressure to the reservoir 14. As such, emission of vapor formed via heating of the pre-vapor formulation housed in the reservoir 14 is facilitated. Once pressure upon the reservoir 14 is relieved, the valve 40 closes and the heated capillary tube 18 discharges any pre-vapor formulation remaining downstream of the valve 40.

FIG. 4 is a longitudinal cross-sectional view of another example embodiment of an e-vaping device. In FIG. 4, the e-vaping device 60 can include a central air passage 24 in an upstream seal 15. The central air passage 24 opens to the inner tube 65. Moreover, the e-vaping device 60 includes a reservoir 14 configured to store the pre-vapor formulation. The reservoir 14 includes the pre-vapor formulation and optionally a storage medium 25 such as gauze configured to store the pre-vapor formulation therein. In an embodiment, the reservoir 14 is contained in an outer annulus between the outer tube 6 and the inner tube 65. The annulus is sealed at an upstream end by the seal 15 and by a stopper 10 at a downstream end so as to prevent leakage of the pre-vapor formulation from the reservoir 14. The heater 19 at least partially surrounds a central portion of a wick 220 such that when the heater is activated, the pre-vapor formulation present in the central portion of the wick 220 is vaporized to form a vapor. The heater 19 is connected to the battery 12 by two spaced apart electrical leads 26. The e-vaping device 60 further includes a mouth-end insert 20 having at least two outlets 21. The mouth-end insert 20 is in fluid communication with the central air passage 24 via the interior of inner tube 65 and a central passage 64, which extends through the stopper 10.

The e-vaping device 60 may include an air flow diverter comprising an impervious plug 30 at a downstream end 82 of the central air passage 24 in seal 15. In at least one example embodiment, the central air passage 24 is an axially extending central passage in seal 15, which seals the upstream end of the annulus between the outer and inner tubes 6, 65. The radial air channel 32 directing air from the central passage 20 outward toward the inner tube 65. In operation, when an adult vaper puffs on the e-vaping device, the puff sensor 16 detects a pressure gradient caused by the drawing of the adult vaper on the e-vaping device, thereby creating a negative pressure, and as a result the control circuitry 11 controls heating of the pre-vapor formulation located in the reservoir 14 by providing power the heater 19.

In one example embodiment, the pre-vapor formulation includes at least one ion exchanger or adsorbant such as Dowex 50W-X8, Lewait CNP 80 and Amberlite IR-120, and may also include nicotine, a combination of glycerol and/or propylene glycol, optionally flavorants as well as organic acids, optionally water, and the like. In example embodiments, the ion exchanger includes insoluble particles, the particles being in a range of about 0.03 mm to about 0.5 mm in size. In example embodiments, the ion exchanger or adsorbant may be included in the pre-vapor formulation at a concentration of, for example, about 0.1% to about 5% by weight of the pre-vapor formulation, and for example about 0.1% to about 0.5%, about 0.5% to about 1%, about 1% to about 2%, about 2% to about 4%, or about 4% to about 5%.

In example embodiments, the addition of the ion exchanger or adsorbant such as, for example, Dowex 50W-X8, Lewait CNP 80 and Amberlite IR-120, to the pre-vapor formulation of an e-vaping device may reduce or substantially prevent the oxidation of the various other ingredients present in the pre-vapor formulation, may reduce or substantially prevent the oxidation of the solid portions of the e-vaping device such as the cartridge that come in contact with the ingredients of the pre-vapor formulation, and may substantially prevent the transfer of free radicals or metals into the vapor generated by the e-vaping device. Thus, the addition of the ion exchangers in amounts that are effective can increase the stability of the pre-vapor formulation.

In example embodiments, because the oxidation of ingredients of the pre-vapor formulation results from the generation of hydroxyl radicals generated by a reaction with oxygen or hydrogen peroxide generated from oxygen catalyzed by free transition metals, the addition of the ion exchangers, which are scavengers or binders of the free transition metals and oxygen, reduces or substantially prevents the formation of hydroxyl radicals, and thus reduces or substantially prevents hydroxyl radicals from reacting with ingredients of the pre-vapor formulation. Accordingly, oxidation of ingredients of the pre-vapor formulation due to the presence of the hydroxyl radicals may be reduced or substantially prevented.

In an example embodiment, the pre-vapor formulation may also include chelating agents, in addition to the mixture of nicotine, water, propylene glycol and/or glycerol, ion exchangers, and potentially organic acids. During operation of the e-vaping device, the ion exchangers present in the pre-vapor formulation may bind most or a majority of free transition metals and bind most of oxygen in the pre-vapor formulation. Any remaining redox active metals that have not been bound by the ion exchangers may in turn react with the high affinity but low capacity chelating agents, where the chelating agents, such as EDTA, DTPA or NTA may bind the remaining free transition metals. As a result of the combined or successive action of the ion exchangers and the chelating agents, the free transition metals are reduced or substantially prevented from transferring into the vapor generated during operation of the e-vaping device or from forming harmful hydroxyl radicals. Likewise, the oxygen content in the formulation solution is substantially reduced in the presence of oxygen ion exchangers resulting in a substantial reduction in reactive oxygen species such as, such for example, hydroxyl radicals.

In some example embodiments, the ion exchangers include Dowex 50W-X8 in the form of a fine mesh of spherical particles in a size range of about 0.03 mm to about 0.3 mm. In example embodiments, the ion exchanger is capable of binding metals as Cu, Ni, Zn, Cd and Pb, which results in the release of H⁺ ions or Na⁺ ions.

In example embodiments, the ion exchangers include Lewait CNP 80, which is a weakly acidic, macroporous, acrylic-based cation exchanger resin having bead in a size range of about 0.3 mm, a substantially high operating capacity and good chemical and mechanical stability. Lewait CNP 80 is capable of binding the heavy metals such as Cu, Ni, Zn, Cd and Pb.

In example embodiments, the ion exchangers include Amberlite IR-120 is a strongly acidic, cation exchange resin having spherical particles in H⁺ or Na⁺ in ionic form. Amberlite IR-120 is insoluble in water and in most common solvents, is stable at elevated temperatures, and has a high exchange capacity over a wide pH range. Amberlite IR-120 is effective in adsorbing the heavy metals such as Cu, Ni, Zn, Cd and Pb.

In example embodiments, the ion exchangers or adsorbants may reduce or substantially prevent oxidation of ingredients of the e-vaping device by preventing the formation of the hydroxyl radicals typically generated by transition metals such as copper, nickel and iron present in portions of the e-vaping device, and thus substantially preventing a reaction of the ingredients of the pre-vapor formulation with hydroxyl radicals. As a result, a longer shelf life of the pre-vapor formulation of an e-vaping device may be achieved, and unwanted transfer of free radicals into the vapor generating during operation of the e-vaping device may be substantially prevented.

In example embodiments, the wick of the e-vaping device may be formed of, or may include, ion exchangers or adsorbants. For example, the wick may be formed of, or include, nanocrystalline cellulose in the form of, for example, a transparent film. The cellulose nanoadsorbent is capable of removing heavy metal ions such as, for example, Cu, Ni or Fe, from aqueous solutions.

In example embodiments, the ion exchangers or adsorbents may be combined with other agents such as sequestering agents of heavy metals or chelators. The sequestering agents may also include chelators such as ethylenediaminetetraacetic acid (EDTA), diethylene triamine pentaacetic acid (DTPA), Nitrilotriacetic acid (NTA) adsorbants, and ion exchange agents. In example embodiments, the ion exchangers in combination with the sequestering agents may reduce or substantially prevent the oxidation of ingredients of the e-vaping device by sequestering or binding with the free transition metals of the solid portions of the e-vaping device or present in formulation ingredients, and reducing or substantially preventing the generation of hydroxyl radicals. The addition of polyols to the formulation would also enhance the probability of increasing the stability of the pre-vapor formulation by substantially preventing oxidation of the ingredients thereof. As a result, a longer shelf life of the pre-vapor formulation of an e-vaping device may be achieved, and the release of harmful free radicals or free metals in the vapor generated during operation of the e-vaping device may also be substantially reduced.

During operation of an e-vaping device, the acids typically protonate the molecular nicotine in the pre-vapor formulation, so that upon heating of the pre-vapor formulation by a heater in the cartridge of the e-vaping device, a vapor having a majority amount of protonated nicotine and a minority amount of unprotonated nicotine is produced, whereby only a minor portion of all the volatilized (vaporized) nicotine typically remains in the gas phase of the vapor. For example, although the pre-vapor formulation may include up to 5% of nicotine, the proportion of nicotine in the gas phase of the vapor may be substantially 1% or less of the total nicotine delivered.

According to at least one example embodiment, the acids present in the pre-vapor formulation have the ability to transfer into the vapor. Transfer efficiency of an acid is the ratio of the mass fraction of the acid in the vapor to the mass fraction of the acid in the liquid. In at least one embodiment, the acid or combination of acids present in the pre-vapor formulation have a liquid to vapor transfer efficiency of about 50% or greater, and for example about 60% or greater. For example, pyruvic acid, tartaric acid and acetic acid have vapor transfer efficiencies of about 50% or greater.

In at least one embodiment, the acid(s) present in the pre-vapor formulation are in an amount sufficient to reduce the amount of nicotine gas phase portion by about 30% by weight or greater, by about 60% to about 70% by weight, by about 70% by weight or greater, or by about 85% by weight or greater, of the level of nicotine gas phase portion produced by an equivalent pre-vapor formulation that does not include the acid(s).

According to at least one example embodiment, the acid(s) present in the pre-vapor formulation include one or more of pyruvic acid, formic acid, oxalic acid, glycolic acid, acetic acid, isovaleric acid, valeric acid, propionic acid, octanoic acid, lactic acid, levulinic acid, sorbic acid, malic acid, tartaric acid, succinic acid, citric acid, benzoic acid, oleic acid, aconitic acid, butyric acid, cinnamic acid, decanoic acid, 3,7-dimethyl-6-octenoic acid, 1-glutamic acid, heptanoic acid, hexanoic acid, 3-hexenoic acid, trans-2-hexenoic acid, isobutyric acid, lauric acid, 2-methylbutyric acid, 2-methylvaleric acid, myristic acid, nonanoic acid, palmitic acid, 4-pentenoic acid, phenylacetic acid, 3-phenylpropionic acid, hydrochloric acid, phosphoric acid, sulfuric acid, and combinations thereof. The pre-vapor formulation may also include a vapor former, optionally water, and optionally flavorants.

In at least one embodiment, the vapor former is one of propylene glycol, glycerin and combinations thereof. In another embodiment, the vapor former is glycerin. In at least one embodiment, the vapor former is included in an amount ranging from about 40% by weight based on the weight of the pre-vapor formulation to about 90% by weight based on the weight of the pre-vapor formulation (e.g., about 50% to about 80%, about 55% to about 75% or about 60% to about 70%).

The pre-vapor formulation optionally includes water. Water can be included in an amount ranging from about 5% by weight based on the weight of the pre-vapor formulation to about 40% by weight based on the weight of the pre-vapor formulation, or in an amount ranging from about 10% by weight based on the weight of the pre-vapor formulation to about 15% by weight based on the weight of the pre-vapor formulation.

The pre-vapor formulation may also include a flavorant in an amount ranging from about 0.01% to about 15% by weight (e.g., about 1% to about 12%, about 2% to about 10%, or about 5% to about 8%). The flavorant can be a natural flavorant or an artificial flavorant. In at least one embodiment, the flavorant is one of tobacco flavor, menthol, wintergreen, peppermint, herb flavors, fruit flavors, nut flavors, liquor flavors, and combinations thereof.

In embodiments, the nicotine is included in the pre-vapor formulation in an amount ranging from about 2% by weight to about 6% by weight (e.g., about 2% to about 3%, about 2% to about 4%, about 2% to about 5%) based on the total weight of the pre-vapor formulation. In at least one embodiment, the nicotine is added in an amount of up to about 5% by weight based on the total weight of the pre-vapor formulation. In at least one embodiment, the nicotine content of the pre-vapor formulation is about 2% by weight or greater based on the total weight of the pre-vapor formulation. In another embodiment, the nicotine content of the pre-vapor formulation is about 2.5% by weight or greater based on the total weight of the pre-vapor formulation. In another embodiment, the nicotine content of the pre-vapor formulation is about 3% by weight or greater based on the total weight of the pre-vapor formulation. In another embodiment, the nicotine content of the pre-vapor formulation is about 4% by weight or greater based on the total weight of the pre-vapor formulation. In another embodiment, the nicotine content of the pre-vapor formulation is about 4.5% by weight or greater based on the total weight of the pre-vapor formulation.

In example embodiments, a concentration of the nicotine in the vapor phase of the pre-vapor formulation is equal to or smaller than substantially 1% by weight.

Example embodiments having thus been described, it will be obvious that the same may be varied in many ways. Such variations are not to be regarded as a departure from the intended spirit and scope of example embodiments, and all modifications as would be obvious to one skilled in the art are intended to be included within the scope of the following claims.

What is claimed is:

1. A pre-vapor formulation of an e-vaping device, the pre-vapor formulation comprising:
at least one of an ion exchanger and a chelating agent;
nicotine; and
a vapor former configured to form a vapor of the pre-vapor formulation.

2. The pre-vapor formulation of claim 1, wherein the ion exchanger comprises at least one of styrene-divinylbenzene, a crosslinked polyacrylate carboxylic acid and a styrene divinylbenzene copolymer.

3. The pre-vapor formulation of claim 1, wherein the ion exchanger is insoluble in the pre-vapor formulation.

4. The pre-vapor formulation of claim 1, wherein the chelating agent comprises at least one of EDTA, DTPA and NTA.

5. The pre-vapor formulation of claim 1, wherein a concentration of the ion exchanger is equal to or greater than about 0.1% and equal to or smaller than about 5% by weight.

6. The pre-vapor formulation of claim 5, wherein the concentration of the ion exchanger is equal to or greater than about 0.1% and equal to or smaller than about 0.5% by weight.

7. The pre-vapor formulation of claim 5, wherein the concentration of the ion exchanger is equal to or greater than about 0.5% and equal to or smaller than about 1% by weight.

8. The pre-vapor formulation of claim 5, wherein the concentration of the ion exchanger is equal to or greater than about 1% and equal to or smaller than about 2% by weight.

9. The pre-vapor formulation of claim 5, wherein the concentration of the ion exchanger is equal to or greater than about 2% and equal to or smaller than about 4% by weight.

10. The pre-vapor formulation of claim 5, wherein the concentration of the ion exchanger is equal to or greater than about 4% and equal to or smaller than about 5% by weight.

11. The pre-vapor formulation of claim 3, wherein the ion exchanger has a size of about 0.03 mm to about 0.5 mm.

12. The pre-vapor formulation of claim 1, wherein the concentration of the chelating agent is equal to or greater than about 0.001% and equal to or smaller than about 0.05%.

13. The pre-vapor formulation of claim 12, wherein the concentration of the chelating agent is equal to or greater than about 0.001% and equal to or smaller than about 0.01%.

14. The pre-vapor formulation of claim 12, wherein the concentration of the chelating agent is equal to or greater than about 0.01% and equal to or smaller than about 0.02%.

15. The pre-vapor formulation of claim 12, wherein the concentration of the chelating agent is equal to or greater than about 0.02% and equal to or smaller than about 0.05%.

16. The pre-vapor formulation of claim 1, further comprising at least one of more acids.

17. An e-vaping device, comprising:
a cartridge including a pre-vapor formulation and a heater configured to heat the pre-vapor formulation via a wick; and
a power source coupled to the cartridge and configured to supply power to the heater;
wherein the pre-vapor formulation includes:
at least one of an ion exchanger and a chelating agent;
nicotine; and
a vapor former configured to form a vapor of the pre-vapor formulation.

18. The e-vaping device of claim 17, wherein the wick includes the at least one of an ion exchanger and a chelating agent.

19. The e-vaping device of claim 17, wherein the chelating agent comprises at least one of EDTA, DTPA and NTA.

20. The e-vaping device of claim 17, wherein the concentration of the chelating agent is equal to or greater than about 0.001% and equal to or smaller than about 0.05%.
